(19) United States
(12) Patent Application Publication
(10) Pub. No.: US 2019/0375487 A1
(43) Pub. Date: Dec. 12, 2019

(54) TRANSMISSION ASSEMBLY

(71) Applicant: Robert George Evans, Brisbane (AU)

(72) Inventor: Robert George Evans, Brisbane (AU)

(21) Appl. No.: 16/470,644

(22) PCT Filed: Dec. 18, 2017
(86) PCT No.: PCT/AU2017/051408

§ 371 Date: Jun. 18, 2019

(30) Foreign Application Priority Data
Dec. 19, 2016 (AU) 2016905237

(51) Int. Cl. B63H 23/30; F16H 3/091; F16H 57/00

(52) U.S. Cl. CPC B63H 23/30; F16H 2200/0034; F16H 57/0037; F16H 3/0915

(57) ABSTRACT

A watercraft transmission assembly including a first drive member adapted to operatively couple to an engine, a second drive member operatively engaged with the first drive member, a third drive member operatively associated with the second drive member, a fourth drive member operatively engaged with the third drive member and an output shaft operatively associated with the fourth drive member and adapted to operatively couple to a pump-jet, wherein in use the rotational speed between the first drive member and the output shaft is altered and the direction of rotation of the fourth drive member is substantially similar to the direction of rotation of the first drive member.

### FIELD OF INVENTION

The present invention relates to a watercraft transmission assembly. The present invention has particular but not exclusive application for personal watercraft having a pump-jet. A personal watercraft is a recreational motorised watercraft that the rider sits or stands on. This use is by way of example only and the invention is not limited to this use.

### BACKGROUND OF THE INVENTION

Personal watercraft such as Jet Skis, WaveRunners and Sea-Doos use pump-jets (also known as hydro-jets or waterjets) to provide higher speeds of up to 40 knots or more compared to a similar sized propeller driven boat. Personal watercraft are also more efficient at higher speeds than comparable propeller driven boats.

A problem with personal watercraft is that the range of the personal watercraft greatly decreases as the speed increases because of the increase in fuel usage.

Currently, to overcome this problem, a user can load extra fuel in additional tanks or expanded fuel tanks. However, this increases the cost of running the personal watercraft and it increases the weight of the personal watercraft.

Another current solution is to run the personal watercraft at a reduced speed. However, this can reduce the enjoyment that is experienced by the user and increase the time required to reach a destination.

### OBJECT OF THE INVENTION

It is an object of the present invention to overcome or at least alleviate one or more of the above problems by developing and using a transmission assembly for a personal watercraft.

### SUMMARY OF THE INVENTION

In one aspect, the present invention broadly resides in a watercraft transmission assembly including

a first drive member adapted to operatively couple to an engine;

a second drive member operatively engaged with the first drive member;

a third drive member operatively associated with the second drive member;

a fourth drive member operatively engaged with the third drive member; and

an output shaft operatively associated with the fourth drive member and adapted to operatively couple to a pump-jet,

wherein in use the rotational speed between the first drive member and the output shaft is altered and the direction of rotation of the fourth drive member is substantially similar to the direction of rotation of the first drive member.

Preferably the rotational speed between the first drive member and the output shaft is altered due to the engagement between the first drive member and the second drive member, the association between the second drive member and the third drive member, the engagement between the third drive member and the fourth drive member and the association between the fourth drive member and the output shaft.

Preferably, the first drive member is a first gear. Preferably the first drive member is coupled to a drive shaft of the engine and rotates at the same speed as the drive shaft of the engine.

Preferably the second drive member is a second gear. Preferably the second drive member is rotated by the first drive member. Preferably the second gear meshes with the first gear.

Preferably the second drive member is associated with the third drive member such that the third drive member rotates at the same speed as the second drive member. Preferably the third drive member is connected to the second drive member. In one embodiment, the second drive member is formed integrally with the third drive member. Preferably the third drive member is a third gear.

Preferably the fourth drive member is a fourth gear. Preferably the fourth drive member is rotated by the third drive member. Preferably the fourth gear meshes with the third gear. Preferably the output shaft is attached to the fourth drive member. In one embodiment, the output shaft is integrally formed with the fourth drive member.

In one embodiment, the first drive member is a first sprocket, the second drive member is a second sprocket, the third drive member is a third sprocket, and the fourth drive member is a fourth sprocket. Preferably the first sprocket drives the second sprocket via a chain. Preferably the third sprocket drives the fourth sprocket via a chain. In another embodiment, the first drive member is a first pulley, the second drive member is a second pulley, the third drive member is a third pulley, and the fourth drive member is a fourth pulley. Preferably the first pulley drives the second pulley via a belt. Preferably the third pulley drives the fourth pulley via a belt.

Preferably the drive members are replaceable to alter the speed between the first drive member and the output shaft.

Preferably the watercraft transmission assembly further includes a cover. Preferably the cover encloses at least a portion of the first drive member. Preferably the cover encloses at least a portion of the fourth drive member. Preferably the cover encloses the second and the third drive member. Preferably the first drive member, the second drive member, the third drive member and the fourth drive member are rotatably mounted in the cover. Preferably the cover is made from aluminium. Alternatively, the cover can be made from cast iron. In one form, the cover includes a fibre reinforced plastic material. Preferably the cover can be opened to assist in replacing drive members to change the rotational speed between the first drive member and the output shaft.

Preferably the watercraft transmission assembly is water cooled. Preferably the cover includes one or more galleries or conduits machined into it, that allow cooling fluid to move through the one or more galleries or conduits drawing heat from the transmission assembly. The one or more galleries or conduits preferably have at least one inlet port and at least one outlet port. Preferably the cooling fluid comes from the same source that is used to cool the engine. In one embodiment, a split line is attached to cooling fluid supply line for the engine, the split line supplying cooling fluid to the inlet port of the watercraft transmission assembly. Preferably the cooling fluid exiting the outlet port of the watercraft transmission assembly joins cooling fluid exiting the engine. In one embodiment, the cooling fluid exiting the engine is used to cool the watercraft transmission assembly.

Preferably the watercraft transmission assembly further includes bearings to rotatably support the drive members within the transmission assembly. Preferably the bearings are sealed bearings.

Preferably the watercraft transmission assembly increases the rotational speed of the fourth drive member relative to the rotational speed of the first drive member. Preferably the ratio of the input speed (rotational speed of the first drive member) to the output speed (rotational speed of the fourth drive member) is in the range of substantially 1:1 to 1:2.4. More preferably the ratio of the input speed to the output speed is in the range of 1:1.3 to 1:2.2. In one form the ratio of the input speed to the output speed is substantially 1:1.3. In another form the ratio of the input speed to the output speed is substantially 1:1.4. In another form the ratio of the input speed to the output speed is substantially 1:1.6. In another form the ratio of the input speed to the output speed is substantially 1:1.8. In a further form the ratio of the input speed to the output speed is substantially 1:1.9. In another form the ratio of the input speed to the output speed is substantially 1:2.0. In another form the ratio of the input speed to the output speed is substantially 1:2.2. In one embodiment, the ratio of the input speed to the output speed is substantially 1:1, this embodiment may be desirable to emulate an input/output ratio of a watercraft without a transmission assembly.

Preferably the ratio of the rotational speed of the first drive member relative to the second drive member is in the range of 22:25 to 25:37. In one form the ratio of the rotational speed of the first drive member relative to the second drive member is substantially 22:25. Preferably in this form, the first drive member is a first gear with 25 teeth and the second drive member is a second gear with 22 teeth. In another form the ratio of the rotational speed of the first drive member relative to the second drive member is substantially 23:29. Preferably in this form, the first drive member is a first gear with 29 teeth and the second drive member is a second gear with 23 teeth. In a further form the ratio of the rotational speed of the first drive member relative to the second drive member is substantially 24:33. Preferably in this form, the first drive member is a first gear with 33 teeth and the second drive member is a second gear with 24 teeth. In another form the ratio of the rotational speed of the first drive member relative to the second drive member is substantially 25:37.

Preferably in this form, the first drive member is a first gear with 37 teeth and the second drive member is a second gear with 25 teeth.

In a further form, the ratio of the rotational speed of the first drive member relative to the second drive member is substantially 35:49. Preferably in this form, the first drive member is a first gear with 49 teeth and the second drive member is a second gear with 35 teeth.

Preferably the ratio of the rotational speed of the third drive member relative to the fourth drive member is in the range of 22:25 to 25:37. In one form the ratio of the rotational speed of the third drive member relative to the fourth drive member is substantially 22:25. Preferably in this form, the third drive member is a third gear with 25 teeth and the fourth drive member is a fourth gear with 22 teeth. In another form the ratio of the rotational speed of the third drive member relative to the fourth drive member is substantially 23:29. Preferably in this form, the third drive member is a third gear with 29 teeth and the fourth drive member is a fourth gear with 23 teeth. In a further form the ratio of the rotational speed of the third drive member relative to the fourth drive member is substantially 24:33. Preferably in this form, the third drive member is a third gear with 33 teeth and the fourth drive member is a fourth gear with 24 teeth. In another form the ratio of the rotational speed of the third drive member relative to the fourth drive member is substantially 25:37. Preferably in this form, the third drive member is a third gear with 37 teeth and the fourth drive member is a fourth gear with 25 teeth.

In a further form the ratio of the rotational speed of the third drive member relative to the fourth drive member is substantially 45:39. Preferably in this form, the third drive member is a third gear with 39 teeth and the fourth drive member is a fourth gear with 45 teeth. In another form the ratio of the rotational speed of the third drive member relative to the fourth drive member is substantially 42:42. Preferably in this form, the third drive member is a third gear with 42 teeth and the fourth drive member is a fourth gear with 42 teeth. In a further form the ratio of the rotational speed of the third drive member relative to the fourth drive member is substantially 39:45. Preferably in this form, the third drive member is a third gear with 45 teeth and the fourth drive member is a fourth gear with 39 teeth. In another form the ratio of the rotational speed of the third drive member relative to the fourth drive member is substantially 37:47. Preferably in this form, the third drive member is a third gear with 47 teeth and the fourth drive member is a fourth gear with 37 teeth. In a further form the ratio of the rotational speed of the third drive member relative to the fourth drive member is substantially 35:49. Preferably in this form, the third drive member is a third gear with 49 teeth and the fourth drive member is a fourth gear with 35 teeth.

In one form the first gear, the second gear, the third gear and the fourth gear are spur gears. In another form, the first gear, the second gear, the third gear and the fourth gear are helical gears. More preferably the helical gears are double helical gears.

In another aspect, the present invention broadly resides in a watercraft transmission assembly including

a first drive member adapted to operatively couple to an engine;

a second drive member operatively engaged with the first drive member;

a third drive member operatively associated with the second drive member;

a fourth drive member operatively engaged with the third drive member; and

an output shaft in a first condition operatively associated with the fourth drive member and in a second condition operatively associated with the first drive member, the output shaft adapted to operatively couple to a pump-jet

wherein in use, in the first condition the rotational speed between the first drive member and the output shaft is altered and the direction of rotation of the fourth drive member is substantially similar to the direction of rotation of the first drive member.

Preferably in the first condition the rotational speed between the first drive member and the output shaft is altered due to the engagement between the first drive member and the second drive member, the association between the second drive member and the third drive member, the engagement between the third drive member and the fourth drive member and the association between the fourth drive member and the output shaft.

Preferably the ratio of the input speed (rotational speed of the first drive member) to the rotational speed of the fourth drive member is in the range of 1:1.2 to 1:3. More preferably the ratio of the input speed to the output speed is in the range of 1:1.9 to 1:2.5. In one form the ratio of the input speed to the output speed is substantially 1:1.9. In another form the ratio of the input speed to the output speed is substantially 1:2.2. In a further form the ratio of the input speed to the output speed is substantially 1:2.5. In another form the ratio of the input speed to the output speed is substantially 1:1.4. In another form the ratio of the input speed to the output speed is substantially 1:1.6. In another form the ratio of the input speed to the output speed is substantially 1:1.8. In another form the ratio of the input speed to the output speed is substantially 1:2.0.

In the first condition, the output shaft is preferably coupled to the fourth drive member. In the first condition, the output shaft is preferably coupled to the fourth drive member by a dog clutch. In the second condition, the output shaft is preferably coupled to the first drive member. In the second condition, the output shaft is preferably coupled to the first drive member by a dog clutch. Preferably the dog clutch is movable between a first position in which the first condition is achieved and a second position in which the second condition is achieved. In one embodiment the dog clutch has a syncromesh. In another embodiment, the dog clutch includes slots which engage with driver teeth on the first drive member or the fourth drive member (depending on which position the dog clutch is in). Preferably a taper is located adjacent the leading edge of each slot to guide the driver teeth into engagement with the slots. Preferably the tapers are located on each side of the dog clutch.

In a further aspect, the present invention broadly resides in a watercraft transmission assembly including

a first drive member adapted to operatively couple to an engine;

a second drive member operatively engaged with the first drive member;

a third drive member operatively associated with the second drive member;

a fourth drive member operatively engaged with the third drive member; and an output shaft operatively associated with the fourth drive member, the output shaft adapted to operatively couple to a pump-jet,

wherein in use, the engine rotates the first drive member, the first drive member rotates the second drive member, the third drive member rotates at the same speed as the second drive member, the third drive member rotates the fourth drive member and the output shaft rotates at the same speed as the fourth drive member such that the rotational speed between the first drive member and the output shaft is altered and the direction of rotation of the fourth drive member is substantially similar to the direction of rotation of the first drive member.

In another aspect, the present invention broadly resides in a watercraft including

an engine;

a pump-jet; and

a transmission assembly including

a first drive member operatively coupled to the engine;

a second drive member operatively engaged with the first drive member;

a third drive member operatively associated with the second drive member;

a fourth drive member operatively engaged with the third drive member; and

an output shaft operatively associated with the fourth drive member, the output shaft operatively coupled to the pump-jet,

wherein the rotational speed between the first drive member and the output shaft is altered and the direction of rotation of the fourth drive member is substantially similar to the direction of rotation of the first drive member.

In another aspect, the present invention broadly resides in a watercraft including

an engine;

a pump-jet; and

a transmission assembly including

a first drive member operatively coupled to the engine;

a second drive member operatively engaged with the first drive member;

a third drive member operatively associated with the second drive member;

a fourth drive member operatively engaged with the third drive member; and

an output shaft in a first condition operatively associated with the fourth drive member and in a second condition operatively associated with the first drive member, the output shaft operatively coupled to the pump-jet

wherein in use, in the first condition the rotational speed between the first drive member and the output shaft is altered and the direction of rotation of the fourth drive member is substantially similar to the direction of rotation of the first drive member.

Preferably the watercraft is a personal watercraft.

Preferably the engine is an internal combustion engine. More preferably the engine is a four-stroke internal combustion engine. In another embodiment the engine is an electric engine.

The features described with respect to one aspect also apply where applicable to all other aspects of the invention. Furthermore, different combinations of described features are herein described and claimed even when not expressly stated.

### BRIEF DESCRIPTION OF THE DRAWINGS

In order that the present invention can be more readily understood reference will now be made to the accompanying drawings which illustrate a preferred embodiment of the invention and wherein:

FIG. 1 is a schematic section view of a watercraft transmission assembly according to an embodiment of the present invention;

FIG. 2 is a schematic section view of a watercraft transmission assembly according to another embodiment of the present invention;

FIG. 3 is a schematic section view of the watercraft transmission assembly of FIG. 2;

FIG. 4a is a right hand view of a dog clutch;

FIG. 4b a section view of the dog clutch of FIG. 4a; and

FIG. 4c is a left hand view of the dog clutch of FIG. 4a.

### DETAILED DESCRIPTION OF THE PREFERRED EMBODIMENT

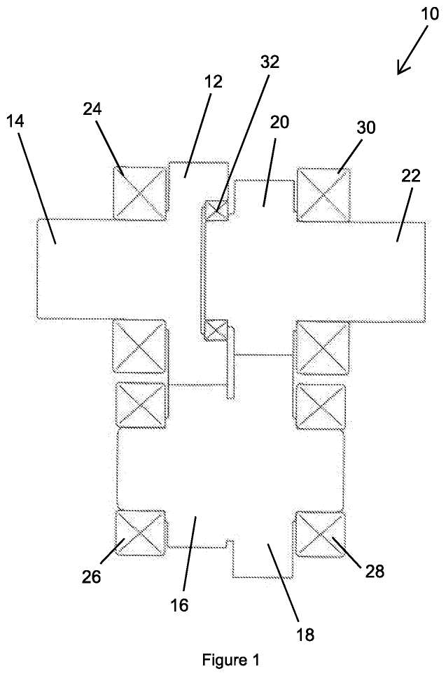

With reference to FIG. 1 there is shown a section schematic view of a watercraft transmission assembly 10. For clarity, the case has been omitted. The watercraft transmission assembly 10 has a first drive member in the form of a first gear 12. The first gear 12 is integrally formed with a drive shaft 14. The drive shaft 14 is coupled to an engine (not shown).

The first gear 12 has 25 teeth and meshes with a second drive member in the form of a second gear 16 having 22 teeth.

A third drive member in the form of a third gear 18 is operatively associated with the second gear 16.

The third gear 18 has 25 teeth and meshes with a fourth drive member in the form of a fourth gear 20 having 22 teeth.

The fourth gear 20 is integrally formed with an output shaft 22. The output shaft 22 is coupled to a pump-jet (not shown).

The first gear 12 and the drive shaft 14 are supported by a bearing 24. The second gear 16 and third gear 18 are supported by bearings 26 and 28. The fourth gear 20 and the output shaft 22 are supported by bearing 30. A bearing 32 is located between the first gear 12 and the fourth gear 20. Bearings 24, 26, 28, 30 and 32 are sealed bearings. An advantage of using sealed bearings is that the bearings are protected from contamination, e.g. from particles of gear teeth or the like.

In use, the engine (not shown) rotates the drive shaft 14 and as such, the first gear 12. The first gear 12 rotates the second gear 16. The third gear 18 rotates at the same speed as the second gear 16. The third gear 18 rotates the fourth gear 20 and as such the output shaft 22. The fourth gear 20 and the output shaft 22 rotate in the same direction as the drive shaft 14 and the first gear 12. Due to the ratio of the teeth on the first gear 12, the second gear 16, the third gear 18 and the fourth gear 20, the output shaft 22 rotates at approximately 1.29 times the speed of the drive shaft 14.

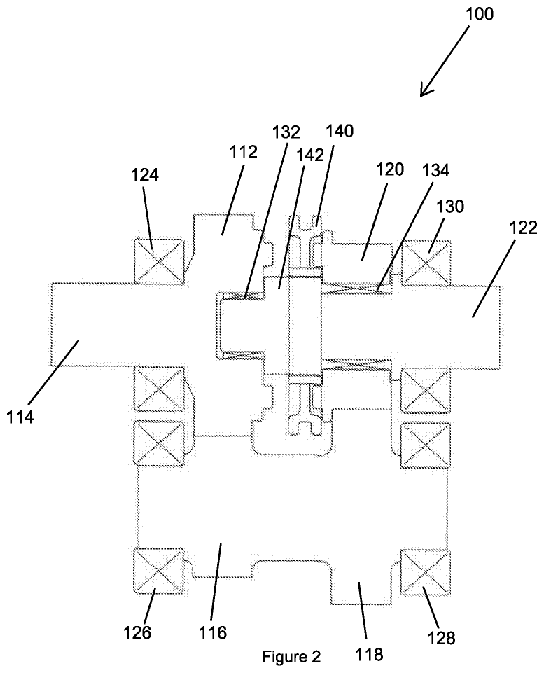

With reference to FIG. 2 there is shown a section schematic view of a watercraft transmission assembly 100 in a first condition. For clarity, the case has been omitted. The watercraft transmission assembly 100 has a first drive member in the form of a first gear 112. The first gear 12 is integrally formed with a drive shaft 114. The drive shaft 114 is coupled to an engine (not shown).

The first gear 112 has 33 teeth and meshes with a second drive member in the form of a second gear 116 having 24 teeth.

A third drive member in the form of a third gear 118 is operatively associated with the second gear 116.

The third gear 118 has 33 teeth and meshes with a fourth drive member in the form of a fourth gear 120 having 24 teeth.

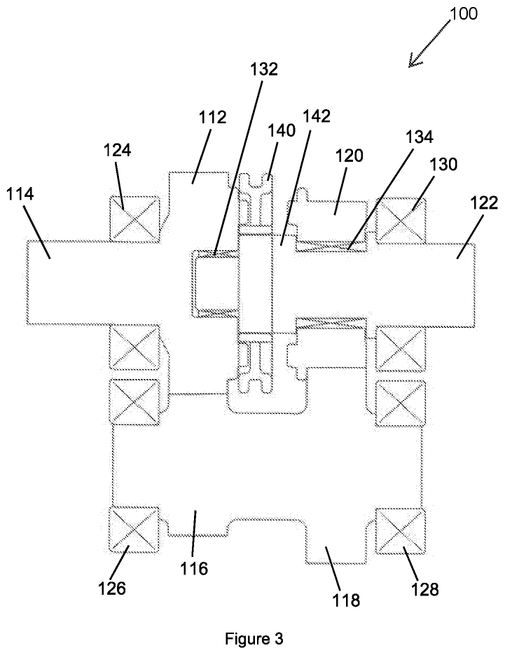

In the first condition, the fourth gear 120 is coupled to an output shaft 122 by a dog clutch 140. The dog clutch 140 is movable along a splined surface 142 of the output shaft 122 between a first position (as seen in FIG. 2) and a second position (as seen in FIG. 3).

The output shaft 122 is coupled to a pump-jet (not shown).

In a second condition as shown in FIG. 3, the output shaft 122 is coupled to the first gear by the dog clutch 140.

The first gear 112 and the drive shaft 114 are supported by a bearing 124. The second gear 116 and third gear 118 are supported by bearings 126 and 128. The output shaft 122 is supported by bearings 130 and 132. A bearing 134 supports the fourth gear 120 on the output shaft 122. Bearings 124, 126, 128, 130, 132 and 134 are sealed bearings. An advantage of using sealed bearings is that the bearings are protected from contamination, e.g. from particles of gear teeth or the like.

In use, with reference to FIG. 2, in the first condition, the engine (not shown) rotates the drive shaft 114 and as such, the first gear 112. The first gear 112 rotates the second gear 116. The third gear 118 rotates at the same speed as the second gear 116. The third gear 118 rotates the fourth gear 120. The fourth gear 120 is coupled to the output shaft 122 which rotates at the same speed as the fourth gear 120.

The output shaft 122 rotates in the same direction as the drive shaft 114 and the first gear 112. Due to the ratio of the teeth on the first gear 112, the second gear 116, the third gear 118 and the fourth gear 120, the output shaft 122 rotates at approximately 1.89 times the speed of the drive shaft 114.

With reference to FIGS. 2 and 3, to change the speed of the output shaft 122, the dog clutch 140 is movable between the first position, which corresponds to the first condition (as seen in FIG. 2) and the second position, which corresponds to the second condition (as seen in FIG. 3).

With reference to FIG. 3, in the second condition, the dog clutch 140 is in the second position and couples the output shaft 122 to the first gear 112 such that the output shaft 122 rotates at the same speed and in the same direction as the drive shaft 114 and the first gear 112.

The ratio of input speed to output speed of the watercraft transmission assembly 10,100 can be changed by changing the number of teeth. For example, for a substantially 1:1.2 ratio of input speed to output speed, the first gear 12,112 has 49 teeth, the second gear 16,116 has 35 teeth, the third gear 18,118 has 39 teeth and the fourth gear 20,120 has 45 teeth. For a substantially 1:1.4 ratio of input speed to output speed, the first gear 12,112 has 49 teeth, the second gear 16,116 has 35 teeth, the third gear 18,118 has 42 teeth and the fourth gear 20,120 has 42 teeth. For a substantially 1:1.6 ratio of input speed to output speed, the first gear 12,112 has 49 teeth, the second gear 16,116 has 35 teeth, the third gear 18,118 has 45 teeth and the fourth gear 20,120 has 39 teeth. For a substantially 1:1.8 ratio of input speed to output speed, the first gear 12,112 has 49 teeth, the second gear 16,116 has 35 teeth, the third gear 18,118 has 47 teeth and the fourth gear 20,120 has 37 teeth. For a substantially 1:2.0 ratio of input speed to output speed, the first gear 12,112 has 49 teeth, the second gear 16,116 has 35 teeth, the third gear 18,118 has 49 teeth and the fourth gear 20,120 has 35 teeth.

The third gear 18,118 is connected to the second gear by a spline (not shown). By swapping out the third gear 18,118 and the fourth gear 20,120 (and output shaft 22 for fourth gear 20), for other gears, the input speed to output speed ratio of the watercraft transmission assembly 10,100 can be changed while retaining the other parts of the watercraft transmission assembly 10,100.

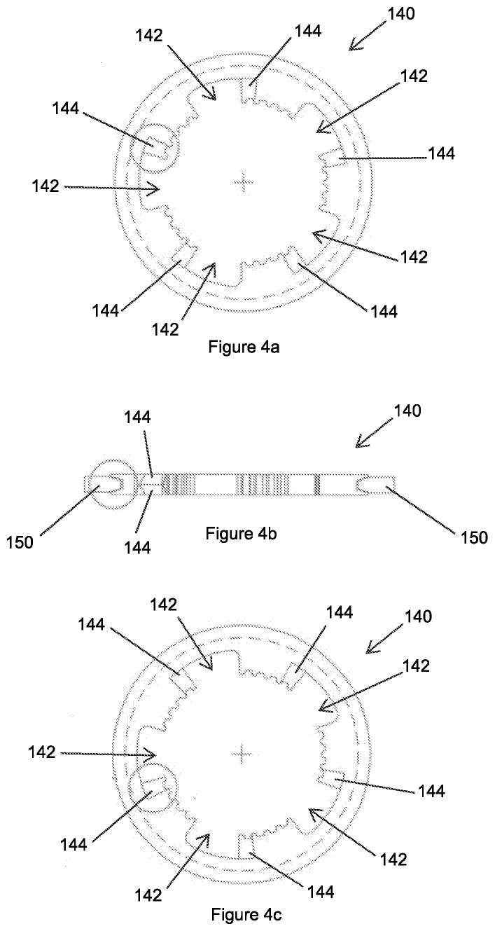

With reference to FIGS. 4a to 4b, there is shown a dog clutch 140 in more detail. The dog clutch 140 can also be referred to as a dog ring. FIG. 4a shows a right hand view of the dog clutch 140, FIG. 4b shows a section view of the dog clutch 140 and a selector fork 150, and FIG. 4c shows a left hand view of the dog clutch 140. The dog clutch has slots 142 which engage with driver teeth (not shown) on a first gear (not shown) and a fourth gear (not shown). Each slot 142 has a tapered edge in the form of a ramp 144 on the leading side of the slot 142, on both sides of the dog clutch 140. In use, the ramps 144 allow the driver teeth (not shown) to slide down into engagement with the slots 142.

### ADVANTAGES

An advantage of the preferred embodiment of the watercraft transmission assembly includes an increased range of the watercraft. Another advantage of the preferred embodiment of the watercraft transmission assembly includes a higher top speed. A further advantage of the preferred embodiment of the watercraft transmission assembly includes longer maintenance intervals.

### VARIATIONS

While the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification the word “comprise” and variations of that word such as “comprises” and “comprising”, are not intended to exclude other additives, components, integers or steps.

1. A watercraft transmission assembly including
a first drive member adapted to operatively couple to an engine;
a second drive member operatively engaged with the first drive member;
a third drive member operatively associated with the second drive member;
a fourth drive member operatively engaged with the third drive member; and
an output shaft operatively associated with the fourth drive member and adapted to operatively couple to a pump-jet,
wherein in use a rotational speed between the first drive member and the output shaft is altered and a direction of rotation of the fourth drive member is substantially similar to a direction of rotation of the first drive member.

2. A watercraft transmission assembly as claimed in claim 1, wherein in use, the engine rotates the first drive member, the first drive member rotates the second drive member, the third drive member rotates at a same speed as the second drive member, the third drive member rotates the fourth drive member and the output shaft rotates at a same speed as the fourth drive member such that the rotational speed between the first drive member and the output shaft is altered and the direction of rotation of the fourth drive member is substantially similar to the direction of rotation of the first drive member.

3. A watercraft transmission assembly as claimed in claim 1, wherein a ratio of the rotational speed of the first drive member to the rotational speed of the fourth drive member is in a range of substantially 1:1 to 1:2.4.

4. A watercraft transmission assembly as claimed in claim 3, wherein the ratio of the rotational speed of the first drive member to the rotational speed of the fourth drive member is in the a range of substantially 1:1.3 to 1:2.2.

5. A watercraft transmission assembly as claimed in claim 3, wherein the ratio of the rotational speed of the first drive member to the rotational speed of the fourth drive member is in the a range of substantially 1:1.4 to 1:2.0.

6. A watercraft transmission assembly as claimed in claim 3, wherein the ratio of the rotational speed of the first drive member to the rotational speed of the fourth drive member is substantially 1:1.4 or 1:1.6.

7. A watercraft transmission assembly as claimed in claim 3, wherein the ratio of the rotational speed of the first drive member to the rotational speed of the fourth drive member is substantially 1:1.8 or 1:2.0.

8. A watercraft transmission assembly including
a first drive member adapted to operatively couple to an engine;
a second drive member operatively engaged with the first drive member;
a third drive member operatively associated with the second drive member;
a fourth drive member operatively engaged with the third drive member; and
an output shaft in a first condition operatively associated with the fourth drive member and in a second condition operatively associated with the first drive member, the output shaft adapted to operatively couple to a pump jet
wherein in use, in the first condition a rotational speed between the first drive member and the output shaft is altered and a direction of rotation of the fourth drive member is substantially similar to a direction of rotation of the first drive member.

9. A watercraft transmission assembly as claimed in claim 8, wherein in the first condition the rotational speed between the first drive member and the output shaft is altered due to the engagement between the first drive member and the second drive member, the association between the second drive member and the third drive member, the engagement between the third drive member and the fourth drive member and the association between the fourth drive member and the output shaft.

10. A watercraft transmission assembly as claimed in claim 8, wherein in the first condition, the output shaft is coupled to the fourth drive member by a dog clutch in a first position and in the second condition, the output shaft is coupled to the first drive member by the dog clutch in a second position.

11. A watercraft transmission assembly as claimed in claim 8, wherein in the first condition, a ratio of the rotational speed of the first drive member to the rotational speed of the fourth drive member is in a range of 1:1.2 to 1:3.

12. A watercraft transmission assembly as claimed in 11, wherein the ratio of the rotational speed of the first drive member to the rotational speed of the fourth drive member is in a range of 1:1.4 to 1:2.0.

13. A watercraft transmission assembly as claimed in claim 1, wherein the first drive member is a first gear, the second drive member is a second gear, the third drive member is a third gear and the fourth drive member is a fourth gear.

14. A watercraft transmission assembly as claimed in claim 1, further including bearings to rotatably support the first drive member, the second drive member, the third drive member and the fourth drive member within the transmission assembly.

15. A watercraft transmission assembly as claimed in claim 14, wherein the bearings are sealed bearings.

16. A watercraft transmission assembly as claimed in claim 1, wherein the first drive member, the second drive member, the third drive member and the fourth drive member are replaceable to alter the speed between the first drive member and the output shaft.

17. A watercraft including
an engine;
a pump-jet; and
a transmission assembly including
a first drive member operatively coupled to the engine;
a second drive member operatively engaged with the first drive member;
a third drive member operatively associated with the second drive member;
a fourth drive member operatively engaged with the third drive member; and
an output shaft operatively associated with the fourth drive member, the output shaft operatively coupled to the pump-jet,
wherein a rotational speed between the first drive member and the output shaft is altered and a direction of rotation of the fourth drive member is substantially similar to a direction of rotation of the first drive member.

18. A watercraft including
an engine;
a pump-jet; and
a transmission assembly including
a first drive member operatively coupled to the engine;
a second drive member operatively engaged with the first drive member;
a third drive member operatively associated with the second drive member;
a fourth drive member operatively engaged with the third drive member; and
an output shaft in a first condition operatively associated with the fourth drive member and in a second condition operatively associated with the first drive member, the output shaft operatively coupled to the pump-jet
wherein in use, in the first condition a rotational speed between the first drive member and the output shaft is altered and a direction of rotation of the fourth drive member is substantially similar to a direction of rotation of the first drive member.

19. A watercraft as claimed in claim 17, wherein the watercraft is a personal watercraft.

20. A watercraft as claimed in claim 18, wherein the engine is a four-stroke internal combustion engine.
